(19) United States
(12) Patent Application Publication
(10) Pub. No.: US 2012/0156045 A1
(43) Pub. Date: Jun. 21, 2012

(54) METHODS, SYSTEMS AND APPARATUS RELATING TO ROOT AND PLATFORM CONFIGURATIONS FOR TURBINE ROTOR BLADES

(75) Inventor: Luke John Ammann, Simpsonville, SC (US)

(73) Assignee: General Electric Company

(21) Appl. No.: 12/971,651

(22) Filed: Dec. 17, 2010

(51) Int. Cl. F01D 5/30; B23P 15/02

(52) U.S. Cl. 416/219 R; 29/889.7

(57) ABSTRACT

A rotor blade assembly for a turbine engine, the rotor blade assembly including: a turbine blade that includes a shank situated between attachment means and an airfoil, the shank having a forward portion and an aft portion; and a platform comprising a platform pressure side and a platform suction side, each of which comprising non-integral components to the other and the turbine blade. The platform may comprise an interface between the platform pressure side and the platform suction side. And, the platform may be configured such that the interface aligns with at least one of the forward portion and the aft portion of the shank.

### BACKGROUND OF THE INVENTION

This present application relates generally to turbine rotor blades and the configuration of root and platform regions related thereto. More specifically, but not by way of limitation, the present application relates to advantageous configurations of root and platform regions for rotor blades having non-integral platforms.

In general, gas turbine engines combust a mixture of compressed air and fuel to produce hot combustion gases. The combustion gases may flow through one or more stages of turbine blades to generate power for a load and/or a compressor. Platforms between the turbine blades may provide a thermal barrier between the hot combustion gases and the turbine wheel and may define an inner flow path of the gas turbine. Due to the high temperatures within the turbine and the motive forces exerted by the combustion gases, the platforms may need to be designed to withstand high temperatures and stresses.

It has been shown that non-integrally formed platforms provide advantages in certain applications. Non-integral platforms, in general, are platforms that are separately formed from the airfoil and root portions of the turbine rotor blade. This type of arrangement, however, may provide an additional leakage path or seam through which hot gases of the flow path may leak. As one of ordinary skill in the art will appreciate, such leakage may have several negative effects, including decreasing the efficiency of the engine, reducing the effectiveness of active cooling strategies, and causing damage to components in the region. In addition, it creates an interface between the platform and the rotor blade that must be securely and rigidly connected. As a result, there is a need for improved apparatus, methods and/or systems relating to rotor blade configurations that include non-integral platform configurations while also discouraging leakage and promote the sturdy connection of between the parts of the turbine rotor blade.

### BRIEF DESCRIPTION OF THE INVENTION

The present application thus describes a rotor blade assembly for a turbine engine that includes: a turbine blade that includes a shank situated between attachment means and an airfoil, the shank having a forward portion and an aft portion; and a platform comprising a platform pressure side and a platform suction side, each of which comprising non-integral components to the other and the turbine blade. The platform may comprise an interface between the platform pressure side and the platform suction side. And, the platform may be configured such that the interface aligns with at least one of the forward portion and the aft portion of the shank.

The present application further describes a rotor blade assembly for a turbine engine that includes: a turbine blade that includes a shank situated between attachment means and an airfoil, the shank having a forward shank face and an aft shank face; the forward shank face including a forward facing surface that comprises an angular width, the forward facing surface extending radially between the attachment means and the airfoil, and the aft shank face including an aft facing surface that comprises an angular width, the aft facing surface extending radially between the attachment means and the airfoil; and a platform comprising a platform pressure side and a platform suction side, each of which comprising non-integral components to the other and the turbine blade. The platform may include an interface between the platform pressure side and the platform suction side. Along a forward section of the interface, the angular position of the interface may include a position within the angular width of the forward shank face; and along an aft section of the interface, the angular position of the interface may include a position within the angular width of the aft shank face.

The present invention further describes a method of configuring a rotor blade assembly to discourage leakage where the rotor blade assembly includes a turbine blade and non-integral platforms including a platform pressure side and a platform suction side, wherein the rotor blade assembly includes a shank situated between attachment means and an airfoil, the shank having a forward shank face and an aft shank face; the forward shank face including a forward facing surface that comprises an angular width, the forward facing surface extending radially between the attachment means and the airfoil, and the aft shank face including an aft facing surface that comprises an angular width, the aft shank face extending radially between the attachment means and the airfoil. In one embodiment, the method includes the step of configuring the platform pressure side and the platform suction side such that, upon assembly, an interface is created that comprises a narrow, radially extending seam between the platform pressure side and a platform suction side. Along a forward section of the interface, the angular position of the interface has a position within the angular width of the forward shank face; and along an aft section of the interface, the angular position of the interface has a position within the angular width of the aft shank face.

These and other features of the present application will become apparent upon review of the following detailed description of the preferred embodiments when taken in conjunction with the drawings and the appended claims.

### BRIEF DESCRIPTION OF THE DRAWINGS

These and other features of this invention will be more completely understood and appreciated by careful study of the following more detailed description of exemplary embodiments of the invention taken in conjunction with the accompanying drawings, in which:

FIG. 1 is a schematic flow diagram of a gas turbine engine that may employ turbine rotor blades in accordance with embodiments of the present application;

FIG. 2 is a sectional view of the gas turbine engine of FIG. 1 sectioned through the longitudinal axis;

FIG. 3 is perspective view of rotor blade assemblies in accordance with an embodiment of the present application;

FIG. 4 is an exploded view of the rotor wheel shown in FIG. 3;

FIG. 5 is a top view of a rotor blade assemblies in accordance with embodiments of the present application;

FIG. 6 is a close-up top view of the rotor blade assemblies of FIG. 5;

FIG. 7 is a top view of rotor blade assemblies in accordance with alternative embodiments of the present application;

FIG. 8 is a top view of rotor blade assemblies in accordance with alternative embodiments of the present application; and

FIG. 9 is a top view of rotor blade assemblies in accordance with alternative embodiments of the present application.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to gas turbine engines that include turbine blade platforms designed to withstand high temperatures and/or stresses. As the temperature of combustion gases flowing within gas turbines increases, the temperature difference between the turbine blades and platforms may increase, which in turn may exert stresses on the platforms. Traditional cooling schemes for integral blades and platforms may diminish temperature effects, but may also degrade turbine performance. Therefore, it has been proposed that platforms may exist as separate, non-integral components from turbine rotor blades (i.e., rather than as a single structure incorporating both the turbine rotor blade and the platform). Non-integral platforms may allow separate temperature profiles to exist for the turbine blades and platforms, which may reduce stresses on both the platforms and the turbine blades. Further, the non-integral platforms may facilitate a reduction in cooling, which in turn may increase the efficiency of the gas turbine engine.

However, having a separate, non-integral platform, necessarily means that an additional seam or joint is introduced to the system, which may provide an additional leakage path through which hot gases from the main flow path of the engine may bypass the airfoils of the rotor blades, which may degrade engine performance. In addition, such leakage may allow for the ingestion of hot flow path gases, which may damage components that were not designed for such exposure. As provided herein and in accordance with exemplary embodiments of the present application, this seam may be configured to reduce or minimize such leakage. In this manner, the benefits of non-integral platforms may be reaped, while the negative aspects, such as leakage, are largely avoided.

In certain embodiments, each platform may be disposed between two turbine rotor blades and supported by the adjacent turbine rotor blades. Further, each platform may interface with an adjacent platform at the location of a turbine rotor blade. As two platforms are brought together, the platforms may form an opening for the turbine rotor blade, thereby allowing the platforms to encircle a turbine rotor blade and form an interface at the rotor blade location.

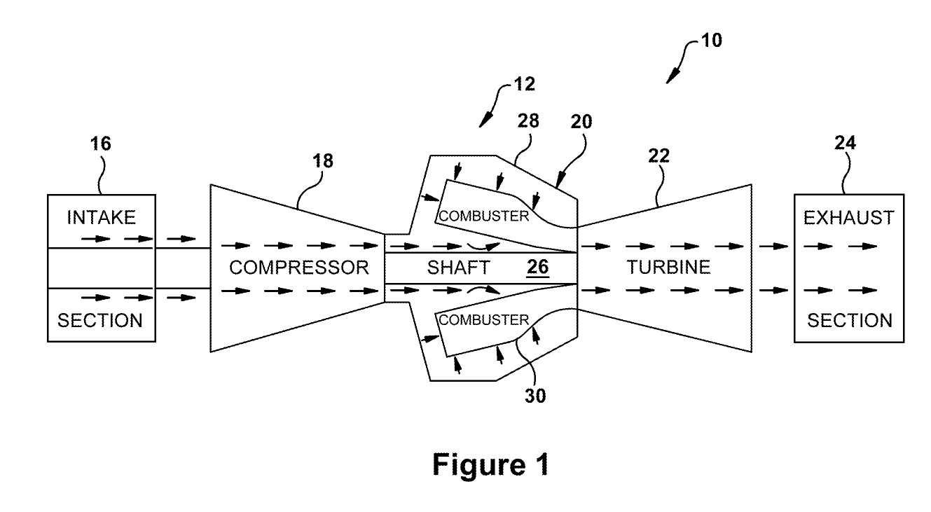

Referring now to FIG. 1, a block diagram of an exemplary system 10 including a gas turbine engine 12 is illustrated. It will be appreciated that system 10 provides an exemplary application in which embodiments of the present invention may be employed. In certain embodiments, the system 10 may include an aircraft, a watercraft, a locomotive, a power generation system, or combinations thereof. The illustrated gas turbine engine 12 includes an air intake section 16, a compressor 18, a combustor section 20, a turbine 22, and an exhaust section 24. The turbine 22 is drivingly coupled to the compressor 18 via a shaft 26. As indicated by the arrows, air may enter the gas turbine engine 12 through the intake section 16 and flow into the compressor 18, which compresses the air prior to entry into the combustor section 20. The illustrated combustor section 20 includes a combustor housing 28 disposed concentrically or annularly about the shaft 26 between the compressor 18 and the turbine 22. The compressed air from the compressor 18 enters combustors 30 where the compressed air may mix and combust with fuel within the combustors 30 to drive the turbine 22. From the combustor section 20, the hot combustion gases flow through the turbine 22, driving the compressor 18 via the shaft 26. For example, the combustion gases may apply motive forces to turbine rotor blades within the turbine 22 to rotate the shaft 26. After flowing through the turbine 22, the hot combustion gases may exit the gas turbine engine 12 through the exhaust section 24.

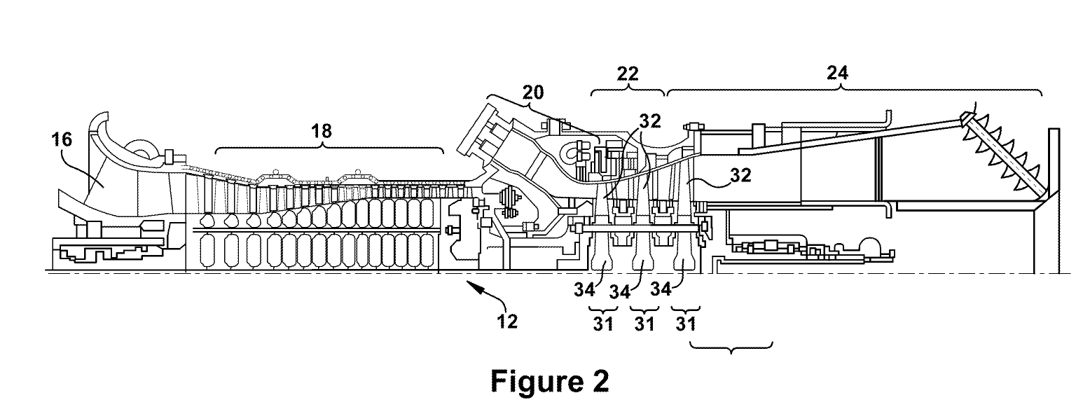

FIG. 2 is a side view of an embodiment of the gas turbine engine 12 of FIG. 1 taken along the longitudinal axis. As depicted, the gas turbine 22 includes three separate turbine rotors 31. Each rotor 31 includes rotor blade assemblies 32 coupled to a rotor wheel 34 that may be rotatably attached to the shaft 26 (FIG. 1). The rotor blade assemblies 32 may include blades that extend radially outward from the rotor wheels 34 and may be partially disposed within the path of the hot combustion gases. As discussed further below, the rotor blade assemblies 32 may include the turbine blades and the turbine blade platforms. Although the gas turbine 22 is illustrated as a three-stage turbine with three rotors 31, the turbine blade platforms described herein may be employed in any suitable type of turbine with any number of stages and shafts. For example, the platforms may be included in a single stage gas turbine, in a dual turbine system that includes a low-pressure turbine and a high-pressure turbine, or in a steam turbine.

As described above with respect to FIG. 1, air may enter through the air intake section 16 and be compressed by the compressor 18. The compressed air from the compressor 18 may then be directed into the combustor section 20 where the compressed air may be mixed with fuel gas. The mixture of compressed air and fuel gas is generally burned within the combustor section 20 to generate high-temperature, high-pressure combustion gases, which may be used to generate torque within the turbine 22. Specifically, the combustion gases may apply motive forces to the rotor assemblies 32 to turn the wheels 34, thereby subjecting the rotor blade assemblies 32 to various mechanical loads and/or stresses. For example, the combustion gases may exert motive forces on the turbine blades within the rotor assemblies 32. Variations in the motive forces may cause vibrations, which may exert stress on the rotor blade assemblies 32. Further, internal temperatures may reach approximately 650° C. or higher which may make the components susceptible to corrosion, oxidation, creep, and/or fatigue. Accordingly, the platforms of the rotor blade assemblies 32 may be comprised or constructed of CMCs to provide higher temperature capabilities.

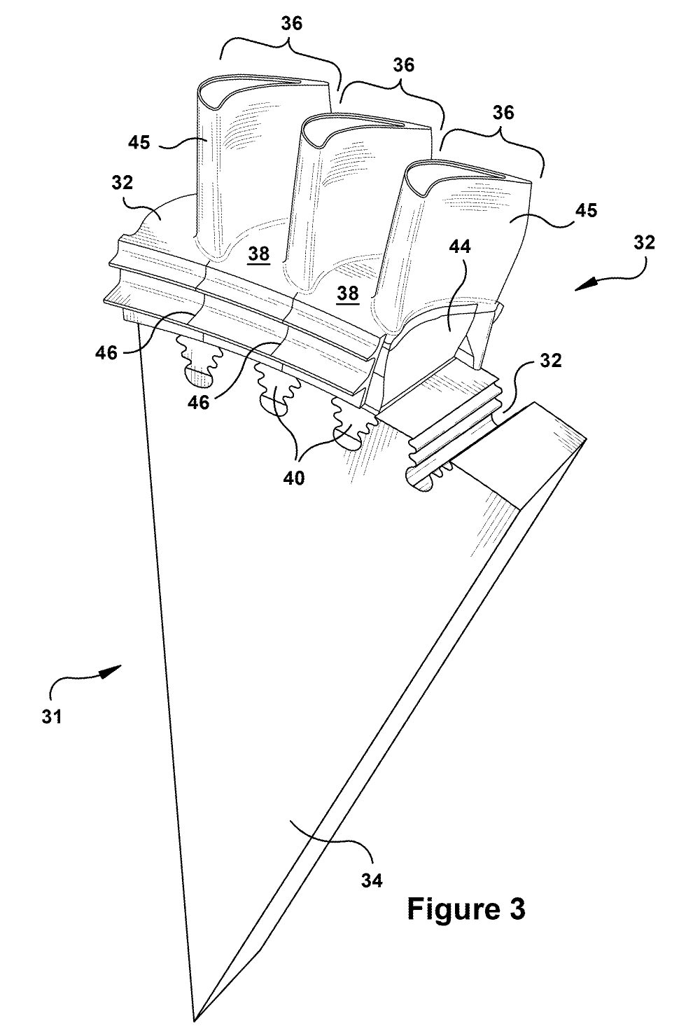

FIG. 3 is a perspective view of a portion of one of the rotor wheels 31 shown in FIG. 2. For illustrative purposes, only a portion of the rotor wheel 31 is illustrated. However, the wheel 31 may generally include a circular structure with rotor assemblies 32 extending radially outward along the circumference of the wheel. The rotor blade assembly 32 may include a turbine blade 36 and a platform 38. In certain embodiments, approximately 60 to 92 rotor blade assemblies 32 may be mounted and spaced circumferentially around the wheel 34 and a corresponding axis of rotation.

The blades 36 and platforms 38 of the rotor blade assemblies 32 may be constructed of a metal, metal alloy, CMC, or other suitable material. Each blade 36 generally includes attachment means, which may be a dovetail 40 that is inserted into corresponding openings 42 within the rotor wheel 34. The openings 42 may be circumferentially spaced at angular positions around the rotor wheel 34. The blade 36 also includes a shank 44 extending radially outward from the dovetail 40. In certain embodiments, the blade 36 may include a contour, ledge, or other support structure, for supporting the platforms 38. For example, the contour may be located on the shank 44 or on an airfoil 45 extending radially outward from the shank 44. The airfoils 45 may be disposed within the path of the hot combustion gases. In operation, the hot combustion gases may exert motive forces on the airfoils 45 to drive the turbine 22 (FIG. 1).

The platforms 38 may be disposed generally between the shanks 44 of the blades 36 and may be radially positioned between the openings 42 within the rotor wheel 34. The blades 36 extend radially outward from the wheel 34 and are circumferentially spaced around the wheel 34 such that spaces are created therebetween. The platforms 38 may be positioned in these circumferential spaces between the blades 36. In other words, the platforms 38 are not merely integral extensions of the blades 36, but rather the platforms 38 fill the spaces, or a portion of the spaces, separating the blades 36 that extend at radial positions from the wheel 34. Further, the platforms 38 may be substantially disposed between the blades 36 so the majority of each platform 38 is located between the same two adjacent blades 36. The platforms 38 may extend between the shanks 44, the airfoils 45, the dovetails 40, or combinations thereof. In certain embodiments, the platforms 38 may be mounted and supported by contours located on the shanks 44. In other embodiments, the platforms 38 may be supported by the sides of the blades 36. The platforms 38 also may include integral cover plates or skirts 48, 49 extending from the sides of the shanks 44.

As noted above, the platforms 38 may exist as independent and/or separate components from the blades 36. In other words, the platforms 38 are not integrally formed with the blades 36. The platforms 38 may be cast or otherwise formed of CMC materials. The platforms 38 may be constructed of a metal, metal alloy, or other suitable material with a CMC coating or layer.

As stated, a platform interface or interface 46 may be formed between each of the neighboring platform components. In accordance with exemplary embodiments of the present invention, as discussed in more detail below, the interface 46 may be positioned at the same circumferential or angular positions as the blades 36, instead of being formed at intermediate angular positions midway between the blades 36. In such embodiments, the platforms 38 may be configured such that, upon assembly, openings for the airfoils 45 of the blades 36 are created when the platforms are joined together at the interface 46. Specifically, each side of the platform 38 may include an opening for a portion of the turbine blade 36. When two platforms 38 are positioned adjacent to each other, the platforms 38 may form an opening corresponding to the profile of the airfoil 45 of the turbine blade 36. In other words, each platform 38 alone does not include an opening for encompassing the entire perimeter of the airfoil 45. Instead, each platform 38 has partial openings for a turbine blade 36 that when interfaced with partial openings of an adjacent platform 38 form an opening that may encircle a turbine blade 36. In this manner, pursuant to embodiments of the present invention, the interfaces 46 between the platforms 38 may be disposed adjacent to or near the turbine blades 36. In this manner, the interface 46 may overlap the shank 44 such that the shank 44 provides an impediment to fluid that would otherwise leak through the interface 46. Accordingly, it will be appreciated that this configuration, i.e. the aligning of the interface 46 with the shank 44 of the turbine blade 36 (along with the other configurations described herein), may reduce or eliminate the leakage of combustion gases and/or cooling fluids that would otherwise enter through the seam created by the platform interface 46, which, of course, results from having non-integral platforms 38.

The platforms 38 described herein may be used with many types and configurations of platforms and turbine blades. For example, the profile, shapes, and relative sizes, of the blades 36 and platforms 38 may vary. In certain embodiments, the blades 36 may have integral cooling passages and/or may be coated, for example, with CMCs, an overlay coating, a diffusion coating, or other thermal barrier coating, to prevent hot corrosion and high temperature oxidation. Further, the blades 36 may include tip shrouds extending radially from the airfoils 45 may to provide vibration control. The platforms 38 may include additional components, such as sealing structures, which may be integrally cast with the platforms 38 or attached as separate components, as discussed in more detail below.

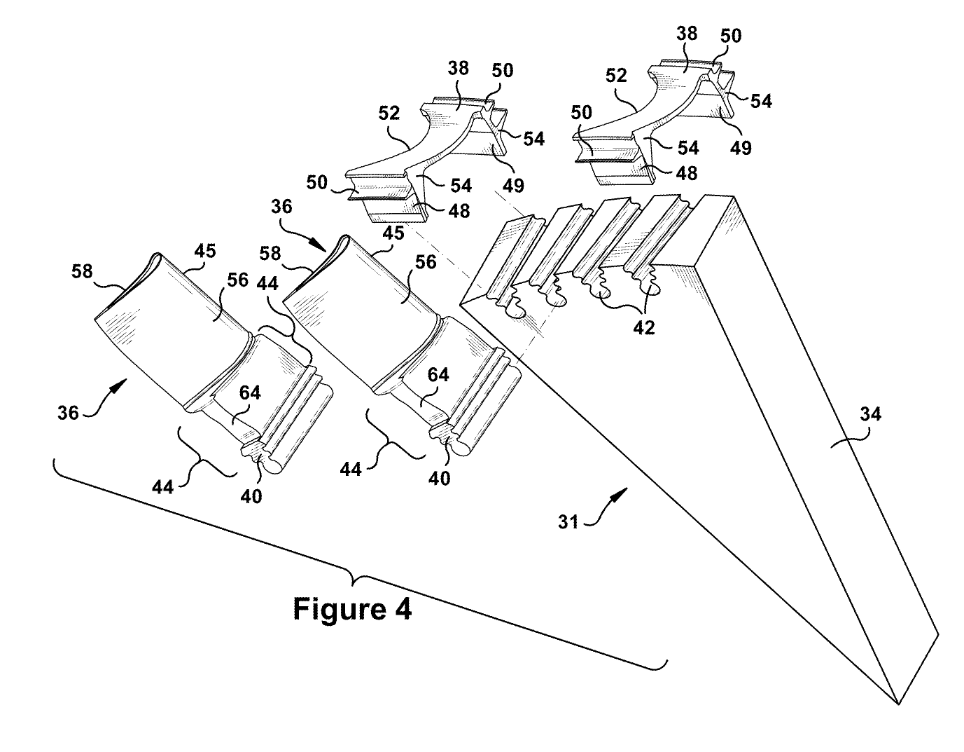

FIG. 4 is an exploded view of the rotor wheel 31 shown in FIG. 3. Each platform 38 may include two integral skirts or cover plates 48, 49 configured to seal the shanks 44 of the blades 36 from the wheel space cavities. It will be appreciated that the platform 38 may be described as including a forward skirt 48 and an aft skirt 49, each of which coincides, respectively, with the forward and aft directions of the turbine engine 12. The platforms 38 also may include angel wings 50 configured to provide sealing of the wheel space cavities. In certain embodiments, the skirts 48, 49 and angel wings 50 may be integrally cast with the platforms 38 and constructed of CMCs. However, in other embodiments, the skirts 48, 49 and/or angel wings 50 may be constructed of other materials and may exist as separate components.

Each platform 38 includes two exterior sides 52 and 54 disposed generally opposite to each other that conform to the contours of the turbine blade 36. Specifically, one exterior side 52 may be designed to interface with a suction side 56 of the turbine blade 36, while the other exterior side 54 may be designed to interface with a pressure side 58 of a turbine blade. As shown, the exterior side 52 includes a generally concave surface designed to conform to the convex profile of the suction side 56 of the turbine blade 36. The exterior side 54 includes a generally convex surface designed to conform to the concave profile of the pressure side 58 of the turbine blade 36. When positioned around the rotor wheel 34, the exterior side 52 may interface with a suction side 56 of one turbine blade 36 located at an angular position on the wheel 34. The other exterior side 54 may interface with a pressure side 58 of another turbine blade 36 that is located at an adjacent angular position on the wheel 34. The suction side 56 of one turbine blade 36 may be contiguous with the exterior side 52 of one platform 38, and the pressure side 58 may be contiguous with the exterior side 54 of another platform 38. As may be appreciated, in other embodiments, the profiles of the exterior sides 52 and 54 may vary to conform to a variety of turbine blade profiles. For example, each exterior side 52 and 54 may have a convex, concave, flat, or other suitable geometry. As noted above, a platform 38 may be generally supported on the sides 52 and 54 by the turbine blades 36. In certain embodiments, the support from the adjacent blades 36 may reduce stresses on the platform and may reduce platform creep.

Each platform 38 may be designed to interface with an adjacent, similar platform 38 to form an intermediate opening designed to encircle or encompass a turbine blade 36. Specifically, the surface 52 may form one portion of the opening and the surface 54 may form another portion of the opening. When two platforms 38 are disposed adjacent to each other, the interface 46 (FIG. 3) between the two platforms may occur at the location of the opening for the turbine blade 36. As noted above, the location of the interface 46 may reduce the leakage of fluids between the cover plates or skirts 48, 49 of the shanks 44 of the turbine blades 36. As shown, upon the assembly of two adjacent platforms 38, the interface 46 may include a radial seam that it is positioned at the substantially same angular position as the shank 44. It will be appreciated that the creation of any seam in a turbine environment invites a certain level leakage. By minimizing this leakage, as embodiments of the present invention proposed, harm to components that result from indigestion may be avoided and increased engine efficiency may be achieved.

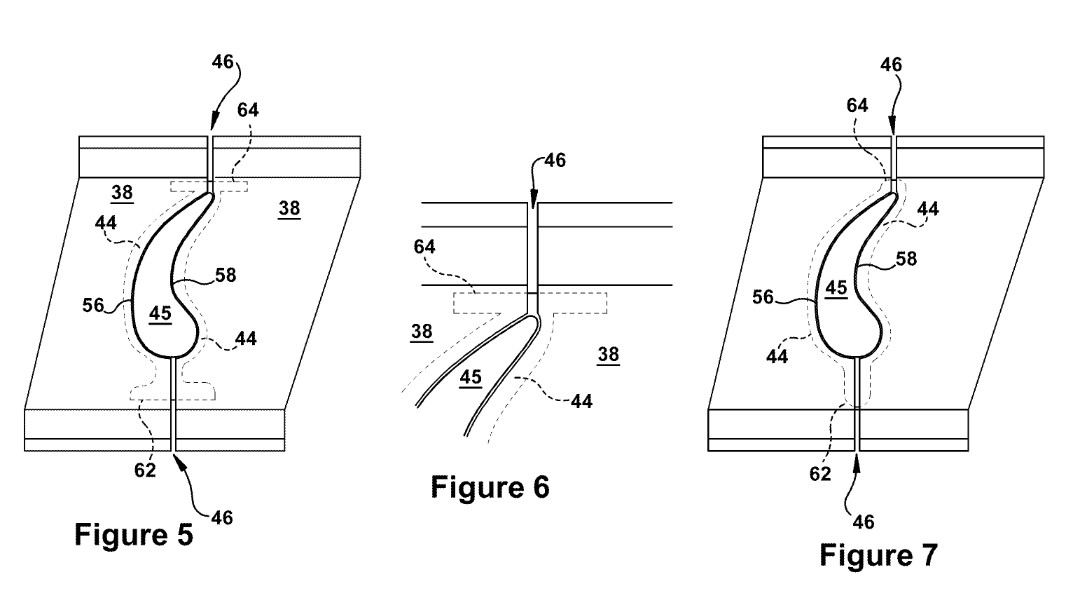

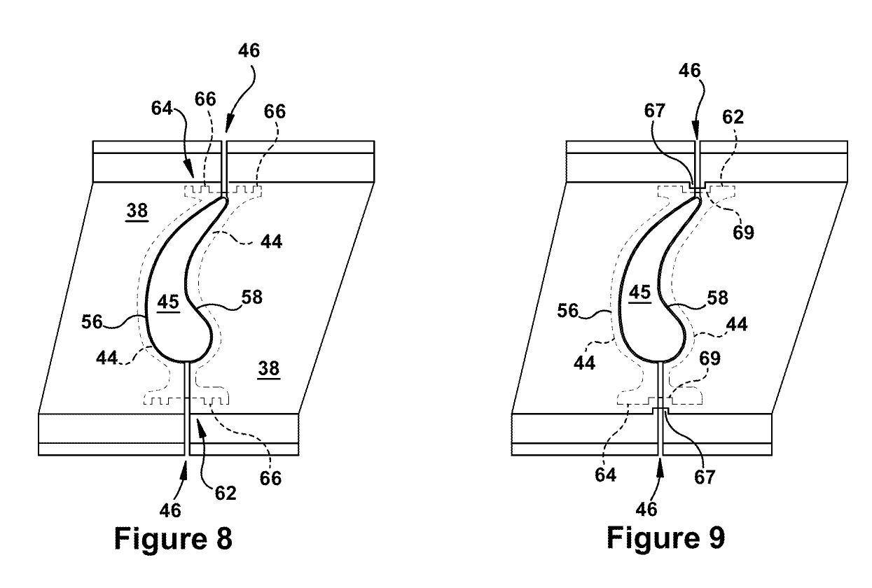

FIGS. 5 through 9 illustrate exemplary embodiments of the present application. As discussed, the non-integral platforms 38 may be configured such that the interface 46 between them discourages leakage. More specifically, according to certain embodiments of the present invention, the non-integral platforms 38 may be configured such that the interface 46 between them occurs at the angular position of the shank 44.

In some preferred embodiments, the shank 44 may be configured to include a forward shank edge or face 62. In some cases, the forward shank edge or face 62 may be narrow and slightly curved (i.e., more like an edge), such as the example shown in FIG. 7. In other cases, such as the embodiments shown in FIGS. 5, 7, 8, and 9, the forward shank edge or face 62 may include a broad or semi-broad planar or slightly curved surface that is aimed or directed approximately upstream or in the forward direction. Similarly, in some preferred embodiments, the aft shank edge or face 64 may be narrow and slightly curved (i.e., more like an edge), such as the example shown in FIG. 7. In other cases, such as the embodiments shown in FIGS. 5, 6, 8, and 9, the aft shank edge or face 62 may include a broad or semi-broad planar or slightly curved surface that is aimed or directed approximately downstream or in the aft direction. FIG. 5 illustrates an embodiment that includes a planar forward shank face 62 and a planar aft shank face 64. Both the forward shank face 62 and the aft shank face 64, as illustrated, may have a circumferential width that extends between two angular or circumferential positions. Also, the forward shank face 62 and the aft shank face 64, as shown, may extend between an inner radial position and an outer radial position, which may approximately coincide with the radial height of the non-integral platforms 38 (or, more specifically, the radial height of the forward and aft skirts 48, 49 of the non-integral platforms 38).

As shown in FIGS. 5 through 9, exemplary embodiments of the present invention may include a rotor blade assembly 32 for a turbine engine. The rotor blade assembly 32 may include a turbine blade 36 that includes a shank 44 situated between attachment means, which has shown may be a dovetail 40, and an airfoil 45. The shank 44 may have a forward portion and an aft portion. The platform 38 may include a platform suction side 56 and a platform pressure side 58, each of which are non-integral components to each other and the turbine blade 36. It will be appreciated that in FIGS. 5 through 9, the platform pressure side 58 is the platform adjacent to the pressure side of that particular airfoil, and that the platform suction side 56 is the platform adjacent to the suction side 56 of that particular airfoil. It will further be appreciated that the platform pressure side 58 may function as the platform suction side 56 for the neighboring turbine blade 36 in that direction. Similarly, it will be appreciated that the platform suction side 56 may function as the platform pressure side 58 for the neighboring turbine blade in the other direction, as depicted in FIGS. 3 and 4.

As stated, the platform may include an interface 46 between the platform pressure side 58 and the platform suction side 56. Preferably, the interface 46 may essentially comprise a narrow seam that results from the junction of the non-integral platform components. In certain embodiments, the platform components may be configured such that the interface 46 aligns with at least one of the forward portion and the aft portion of the shank 44. In other embodiments, the interface 46 aligns with both the forward shank face 62 and the aft shank face 64 of the shank 44.

In some embodiments, the forward portion of the shank 44 may include a forward shank face 62 and the aft portion of the shank 44 may include an aft shank face 64. In some preferred embodiments, the forward shank face 62 includes a forward facing surface that comprises a circumferential or angular width that extends radially between the attachment means and the airfoil. Similarly, the aft shank face 64 includes an aft facing surface that comprises an angular width that extends radially between the attachment means and the airfoil. In such cases, the angular position of the interface 46 may be configured to include a position within the angular width of the forward shank face 62. Further, the angular position of the interface 46 may be configured to include a position within the angular width of the aft shank face 64.

As shown, the platform pressure side 58 may have a forward skirt 48 and an aft skirt 48. Similarly the platform suction side 56 may have a forward skirt 48 and an aft skirt 48. It will be appreciated that the skirt is typically configured to prevent the flow of hot gases from entering the inner radial regions of the rotor assembly. It will further be appreciated that the interface 46 between the platform pressure side 58 and the platform suction side 56 may be described as including a forward interface 46 and an aft interface 46. The forward interface 46 may include an approximate radially extending seam formed between the forward skirt 48 of the platform pressure side 58 and the forward skirt 48 of the platform suction side 56. In some preferred embodiments, the angular position of the forward interface 46 may have a position within the angular width of the forward shank face 62. More preferably, the angular position of the forward interface 46 may be the approximate angular midpoint of the forward shank face 62.

The platform pressure side 58 may include an aft skirt 49, and the platform suction side 56 may include an aft skirt 49. In such cases, the aft interface 46 may include an approximate radially extending seam formed between the aft skirt 49 of the platform pressure side 58 and the aft skirt 49 of the platform suction side 56. In some preferred embodiments, the angular position of the aft interface 46 comprises a position within the angular width of the aft shank face 64. More preferably, the angular position of the aft interface 46 may be the approximate angular midpoint of the aft shank face 64.

The forward skirt 48 of the platform pressure side 58 and the forward skirt 48 of the platform suction side 56 may be configured such that the forward interface 46 extends the radial height of the forward shank face 62. The aft skirt 49 of the platform pressure side 58 and the aft skirt 49 of the platform suction side 56 may be configured such that the aft interface 46 extends the radial height of the aft shank face 64. The forward shank face 62 may include a forward facing surface that comprises an angular width. The forward shank face 62 may extend radially between the attachment means and the airfoil. Similarly, the aft shank face 64 may include an aft facing surface that comprises an angular width. The aft shank face 64 may extend radially between the attachment means and the airfoil. As stated, the alignment or approximate alignment of the interface 46 and the shank face impedes leakage through the interface 46. In part, this is accomplished by creating a torturous path through which the coolant must pass.

In some embodiments, stealing structure may be formed on the forward shank face 62 and/or the aft shank face 64 to further inhibit the leakage flow through the interface 46 and the cavity formed between the platform skirts 48, 49 and the shank 44. One preferred embodiment includes axially jutting ridges 66 that extends radially along the forward shank face 62 and/or the aft shank face 64. In one embodiment, the forward shank face 62 may include a plurality of the ridges 66. The cross-section of the ridges 66, as shown, may be rectangular, though other shapes are also possible. The ridges 66 may be substantially parallel to each other. In addition, the forward shank face 62 may include at least one ridge 66 on each side of the interface 46. In one preferred embodiment, each ridge 66 may extend substantially the entire radial height of the forward shank face 62. It will be appreciated that the same configuration may also be formed on the aft shank face 64.

In another embodiment, as illustrated in FIG. 9, adjacent to the forward interface 46, the platform pressure side 58 may include an axially extending lip 67 that juts toward the forward shank face 62. In addition, adjacent to the forward interface 46, the platform suction side 56 may include an axially extending lip 67 that juts toward the forward shank face 62. As illustrated, the forward shank face 62 may include a radially extending groove 69 formed therein into which the lip 67 of the platform pressure side 58 and the lip 67 of the platform suction side 56 extend. In this manner, the lip 67 of the platform pressure side 58 and the groove 69 are configured to comprise an axial overlap. Thusly, the lip 67 of the platform suction side 56 and the groove 69 are configured to comprise an axial overlap. It will be appreciated that the axial overlap creates a torturous path through which leakage must travel. It will be appreciated that this configuration may also be formed on the aft portion of the platform and shank with similar results.

In another embodiment (not shown), the forward skirt 48 of the platform pressure side 58 and the forward shank face 62 may have interlocking ridges 66. That is, the forward skirt 48 of the platform pressure side 58 may have a ridge 66 that overlaps axially with a ridge 66 formed on the forward shank face 62. Similarly, in some embodiments, the forward skirt 48 of the platform suction side 56 and the forward shank face 62 may also include interlocking ridges 66. The ridges 66 may extend the entire radial height of the platform pressure side 58, the platform suction side 56, and/or the forward shank face 62. Again, interlocking ridges 66 create a torturous path through which the leakage must flow and enhance the sealing characteristics of the configuration.

The present application further includes a novel method of configuring a rotor blade assembly having non-integral platforms that discourages leakage. The rotor blade assembly may include a turbine blade and may include a platform pressure side 58 and a platform suction side 56. The rotor blade may include a shank 44 situated between attachment means and an airfoil. The shank 44 may have a forward shank face 62 and an aft shank face 64. The forward shank face 62 may include a forward facing surface that comprises an angular width that extends radially between the attachment means and the airfoil. The aft shank face 64 may include an aft facing surface that comprises an angular width that extends radially between the attachment means and the airfoil.

The method may include the step of configuring the platform pressure side 58 and the platform suction side 56 such that, upon assembly, an interface 46 is created that comprises a narrow, radially extending seam between the platform pressure side 58 and a platform suction side 56. Along a forward section of the interface 46, the angular position of the interface 46 may comprise a position within the angular width of the forward shank face 62. Along an aft section of the interface 46, the angular position of the interface 46 may comprise a position within the angular width of the aft shank face 64.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A rotor blade assembly for a turbine engine, the rotor blade assembly comprising:
a turbine blade that includes a shank situated between attachment means and an airfoil, the shank having a forward portion and an aft portion; and
a platform comprising a platform pressure side and a platform suction side, each of which comprising non-integral components to the other and the turbine blade;
wherein:
the platform comprises an interface between the platform pressure side and the platform suction side; and
the platform is configured such that the interface aligns with at least one of the forward portion and the aft portion of the shank.

2. The rotor blade assembly according to claim 1, wherein:
the forward portion of the shank comprises a forward shank face;
the aft portion of the shank comprises an aft shank face; and
the interface aligns with both the forward shank face and the aft shank face.

3. The rotor blade assembly according to claim 2, wherein:
the forward shank face includes a forward facing surface that comprises an angular width, the forward facing surface of the forward shank face extending radially between the attachment means and the airfoil;
the aft shank face includes an aft facing surface that comprises an angular width, the forward facing surface of the aft shank face extending radially between the attachment means and the airfoil;
the angular position of the interface comprises a position within the angular width of the forward shank face; and
the angular position of the interface comprises a position within the angular width of the aft shank face.

4. The rotor blade assembly according to claim 2, wherein:
the platform pressure side comprises a forward skirt;
the platform suction side comprises a forward skirt;
the interface includes a forward interface, the forward interface comprising an approximate radially extending seam formed between the forward skirt of the platform pressure side and the forward skirt of the platform suction side;
the forward shank face comprises an angular width; and
the angular position of the forward interface comprises a position within the angular width of the forward shank face.

5. The rotor blade assembly according to claim 4, wherein:
the platform pressure side comprises an aft skirt;
the platform suction side comprises an aft skirt;
the interface includes an aft interface, the aft interface comprising an approximate radially extending seam formed between the aft skirt of the platform pressure side and the aft skirt of the platform suction side;
the aft shank face comprises an angular width; and
the angular position of the aft interface comprises a position within the angular width of the aft shank face.

6. The rotor blade assembly according to claim 4, wherein the angular position of the forward interface comprises the approximate angular midpoint of the forward shank face.

7. The rotor blade assembly according to claim 5, wherein:
the forward shank face includes a forward facing surface that comprises an angular width, the forward facing surface of the forward shank face extending radially between the attachment means and the airfoil; and
the aft shank face includes an aft facing surface that comprises an angular width, the forward facing surface of the aft shank face extending radially between the attachment means and the airfoil.

8. The rotor blade assembly according to claim 7, wherein:
the forward skirt of the platform pressure side and the forward skirt of the platform suction side are configured such that the forward interface extends the radial height of the forward shank face; and
the aft skirt of the platform pressure side and the aft skirt of the platform suction side are configured such that the aft interface extends the radial height of the aft shank face.

9. The rotor blade assembly according to claim 2, wherein
the platform pressure side comprises an aft skirt;
the platform suction side comprises an aft skirt;
the interface includes an aft interface, the aft interface comprising an approximate radially extending seam formed between the aft skirt of the platform pressure side and the aft skirt of the platform suction side;
the aft shank comprises an angular width; and
the angular position of the aft interface comprises a position within the angular width of the aft shank face.

10. The rotor blade assembly according to claim 9, wherein the angular position of the aft interface comprises the approximate angular midpoint of the aft shank face.

11. The rotor blade assembly according to claim 1, wherein:
the platform pressure side and the platform suction side are configured to form an opening that, upon assembly, encircles the airfoil near a base of the airfoil;
the attachment means comprises a dovetail; and
the interface is substantially aligned with a forward edge of the airfoil and an aft edge of the airfoil.

12. The rotor blade assembly according to claim 2, further comprising axially jutting ridges that extends radially along at least one of the forward shank face and the aft shank face and are configured to hinder leakage flow that enters through the interface and flows between the shank face and the platform.

13. The rotor blade assembly according to claim 12, wherein:
the forward shank face comprises a plurality of the ridges;
in relation to each other, the ridges are substantially parallel;
the forward shank face comprises at least one ridge on each side of the interface; and
each ridge extends substantially the entire radial height of the forward shank face.

14. The rotor blade assembly according to claim 7, wherein:
the forward skirt of the platform pressure side and the forward skirt of the platform suction side are configured such that the forward interface extends the radial height of the forward shank face;
adjacent to the forward interface, the platform pressure side comprises an axially extending lip that the juts toward the forward shank face;
adjacent to the forward interface, the platform suction side comprises an axially extending lip that juts toward the forward shank face; and
the forward shank face comprises a radially extending groove formed therein into which the lip of the platform pressure side and the lip of the platform suction side extend.

15. The rotor blade assembly according to claim 14, wherein the lip of the platform pressure side and the groove are configured to comprise an axial overlap; and
wherein the lip of the platform suction side and the groove are configured to comprise an axial overlap.

16. The rotor blade assembly according to claim 7, wherein:
the forward skirt of the platform pressure side and the forward skirt of the platform suction side are configured such that the forward interface extends the radial height of the forward shank face;
the forward skirt of the platform pressure side and the forward shank face comprise interlocking ridges;
the forward skirt of the platform suction side and the forward shank face comprise interlocking ridges;
at least one ridge on the forward skirt of the platform pressure side extends substantially the entire radial height of the platform pressure side;
at least one ridge on the forward skirt of the platform suction side extends substantially the entire radial height of the platform suction side;
at least one ridge on the forward shank face extends substantially the entire radial height of the forward shank face; and
interlocking comprises having at least an axial overlap.

17. The rotor blade assembly according to claim 2, further comprising a plurality of turbine blades; a plurality of platform suction sides; and a plurality of platform pressure sides; each of the platform suction sides and platform pressure sides being similar in configuration and disposed in a circumferential arrangement to define a plurality of openings configured to encircle the airfoils of the plurality of turbine blades; and
further comprising a rotor wheel with a plurality of circumferentially spaced rotor wheel attachment means configured to receive the turbine blade attachment means of each of the turbine blades at predetermined angular positions around the rotor wheel.

18. A rotor blade assembly for a turbine engine, the rotor blade assembly comprising:
a turbine blade that includes a shank situated between attachment means and an airfoil, the shank having a forward shank face and an aft shank face; the forward shank face including a forward facing surface that comprises an angular width, the forward facing surface extending radially between the attachment means and the airfoil, and the aft shank face including an aft facing surface that comprises an angular width, the aft facing surface extending radially between the attachment means and the airfoil; and
a platform comprising a platform pressure side and a platform suction side, each of which comprising non-integral components to the other and the turbine blade;
wherein:
the platform comprises an interface between the platform pressure side and the platform suction side;
along a forward section of the interface, the angular position of the interface comprises a position within the angular width of the forward shank face; and
along an aft section of the interface, the angular position of the interface comprises a position within the angular width of the aft shank face.

19. The rotor blade assembly according to claim 18, wherein:
the platform pressure side comprises a forward skirt and an aft skirt;
the platform suction side comprises a forward skirt and an aft skirt;
the forward section of the interface comprises an approximate radially extending seam formed between the forward skirt of the platform pressure side and the forward skirt of the platform suction side;
the forward shank face comprises an angular width;
the angular position of the forward interface comprises the approximate angular midpoint of the forward shank face;
the aft section of the interface comprises an approximate radially extending seam formed between the aft skirt of the platform pressure side and the aft skirt of the platform suction side;
the aft shank face comprises an angular width; and
the angular position of the aft interface comprises the approximate angular midpoint of the aft shank face.

20. A method of configuring a rotor blade assembly to discourage leakage where the rotor blade assembly includes a turbine blade and non-integral platforms including a platform pressure side and a platform suction side, wherein the rotor blade assembly includes a shank situated between attachment means and an airfoil, the shank having a forward shank face and an aft shank face; the forward shank face including a forward facing surface that comprises an angular width, the forward facing surface extending radially between the attachment means and the airfoil, and the aft shank face including an aft facing surface that comprises an angular width, the aft shank face extending radially between the attachment means and the airfoil; the method including the steps of:
configuring the platform pressure side and the platform suction side such that, upon assembly, an interface is created that comprises a narrow, radially extending seam between the platform pressure side and a platform suction side;
wherein along a forward section of the interface, the angular position of the interface comprises a position within the angular width of the forward shank face; and
wherein along an aft section of the interface, the angular position of the interface comprises a position within the angular width of the aft shank face.

21. The method according to claim 20, wherein the angular position of the aft interface comprises the approximate angular midpoint of the aft shank face; and
wherein the angular position of the forward interface comprises the approximate angular midpoint of the forward shank face.
